(19) United States
(12) Patent Application Publication
(10) Pub. No.: US 2019/0392472 A1
(43) Pub. Date: Dec. 26, 2019

(54) SYSTEM AND METHOD OF DETECTING FRAUD IN THE PROVISION OF A DEAL FOR A SERVICE ON A MOBILE DEVICE

(71) Applicant: DROPBOX, INC., San Francisco, CA (US)

(72) Inventors: Will Stockwell, San Francisco, CA (US); Alex Sydell, San Francisco, CA (US); Tony Grue, San Francisco, CA (US); Kyle Consalus, San Francisco, CA (US)

(21) Appl. No.: 16/563,085

(22) Filed: Sep. 6, 2019

Related U.S. Application Data
(63) Continuation of application No. 13/766,333, filed on Feb. 13, 2013.
(60) Provisional application No. 61/706,111, filed on Sep. 26, 2012.

(51) Int. Cl. G06Q 30/02

(52) U.S. Cl. CPC G06Q 30/0225

(57) ABSTRACT

A system and method for detecting and accounting for the improper use of a deal code on a mobile device. When the user initially configures the mobile device, the third-party provider receives information from the mobile device that includes user information, mobile device information, a deal code associated with a third-party service, information about an application program preloaded on the mobile device associated with the service, and a hash value that is at least partially calculated based on the foregoing. The third-party service provider calculates a second hash value at least partially based on the received information and based on other predetermined information and compares the first hash value to the second hash value. Based on the comparison, the system determines if use of the deal code is improper and, if so, tracks the user and mobile device information to prevent improper use of the deal code.

### CLAIM OF PRIORITY

This application is a continuation of U.S. application Ser. No. 13/766,333, which claims the benefit of priority under 35 U.S.C. § 119(e) to U.S. Provisional Patent Application No. 61/706,111, filed Sep. 26, 2012, entitled, “System and Method of Detecting Fraud in the Provision of a Deal for a Service on a Handheld Device,” which is incorporated herein by reference in its entirety.

### BACKGROUND

Today's smart mobile devices can, and in some cases do, replace desktop and laptop computers. However, mobile devices have limited storage space for files, photos and videos. As a result, the mobile device hardware limits the user's ability to store files, photos, and videos on the mobile device. In response to this need, some content management services now enable cloud-based cross-platform content synchronization and sharing, which enables users to conveniently upload, store, and view files on any device associated with the account.

There are many competing cloud-based services and mobile users are free to download any available third-party application and service. However, users must typically sift through hundreds of applications in an application store to find one that satisfies their needs. Moreover, application and service providers may struggle to differentiate in this highly competitive market.

However, competition for users' application downloads has created new security risks. Because some mobile device manufactures use open source code for the operating system, hackers can modify applications and hack the mobile device to: (1) change how the mobile device operates; and (2) load applications on a mobile device that were not intended to run on the mobile device. Moreover, hackers may also pirate applications and files to illegitimately receive services and terms of service on a mobile device that are not eligible for such services or terms of service.

The present disclosure recognizes and addresses both the foregoing and other considerations of prior art system and methods in providing a solution to the limitations of the prior art.

### SUMMARY

A computer-implemented method of confirming validity of a code (e.g., deal code) associated with a set of service terms (e.g, deal) on a mobile device using at least one processor, in various embodiments, may include receiving information from a mobile device, wherein the information may include: (a) user information, (b) mobile device information, (c) a deal code that is associated with a third-party service and that is preloaded in memory within the mobile device. In various embodiments, the deal code may be associated with a set of service terms, and a hash value that is based on the user information, the mobile device information, and the deal code. In response to receiving the information the computer-implemented method may calculate a second hash value that is based on the information and other predetermined information and compare the second hash value to the first hash value. In various embodiments, the computer-implemented method may determine whether the deal code is properly used with the mobile device at least partially based on the comparison of the second hash value to the first hash value and, in response to determining that the deal code is properly used with the mobile device, accounting for the deal.

In various embodiments, the mobile device information may include: (1) a mobile device identification number; (2) an operating system version number; and (3) an application version number associated with an application that is preloaded on the mobile device.

In some embodiments, the first hash value may be further based on the application version number and the operating system version number. In other embodiments, the other predetermined information may include: (1) a predetermined application version number associated with the deal code; and (2) a predetermined operating system version number that is associated with the deal code. In still further embodiments, accounting for the deal may further include adding the user information and the mobile device identification number to a database that is used to prevent the user, and any other user of the mobile device, from obtaining a particular set of service terms, for the third-party service, associated with the deal code.

In various embodiments, determining whether the deal code is properly used with the mobile device may further include granting, to the user, a particular set of terms for the third-party service. In other embodiments, determining whether the deal code is properly used with the mobile device further may include determining whether the mobile device qualifies the user for the deal associated with the deal code, and determining whether the application has been modified. In some of these embodiments, if the application has been modified, the method further may include adding the user information and the mobile device identification number to a database that is used to prevent improper use of the deal code.

A mobile device, in various embodiments, may include: (1) at least one processor; (2) memory operatively coupled to the at least one processor; (3) a deal code stored in the memory, the deal code being associated with a service; (4) an application program stored in the memory that is used to provide the service on the mobile device, wherein the application program has an application version number; and (5) an operating system having an operating system version number. In some embodiments, at least one processor is configured to, upon the setup of the mobile device: (a) receive user information from a user; (b) retrieve the deal code from the memory; (c) retrieve the application version number; (d) retrieve the operating system version number; (e) create a hash value that is based on the user information, the deal code, the application version number and the operating system version number; (f) transmit the user information, the deal code, the application version number, the operating system version number, the mobile device identification number and the hash value to a third-party associated with the service; (g) receive a notification from the third-party regarding the provision of the service that is based on a result of a comparison of the hash value with a second hash value calculated by provider of the service; and (h) in response to receiving the notification from the third-party, enable setup of the service on the mobile device.

### BRIEF DESCRIPTION OF THE DRAWINGS

Various embodiments of a computer system for: (1) associating particular contract terms for a third-party service with a mobile device during an out-of-box experience for the mobile device; and (2) detecting abuse with regard to obtaining the particular contract terms are described below. In the course of this description, reference will be made to the accompanying drawings, which are not necessarily drawn to scale, and wherein:

FIG. 1 shows a block diagram of a content management system in accordance with an embodiment of the present system;

FIG. 2 shows a block diagram of a computer that may be used, for example, as a client or server computer within the context of the content management system of FIG. 1;

FIGS. 3-4 show flow diagrams that generally illustrate various steps executed by a content management system in accordance with various embodiments of the present system of FIG. 1; and

FIGS. 5-12 show screen shots from a mobile device that illustrate the user experience associated with setting up a mobile device in accordance with an embodiment of the present system and method.

### DETAILED DESCRIPTION

Various embodiments will now be described. It should be understood that the present disclosure may be embodied in many different forms and should not be construed as limited to the embodiments set forth herein. Like numbers refer to like elements throughout.

### System Overview

The present disclosure, in accordance with various embodiments, provides a content management server that may receive information from a mobile device during the device's initial activation and setup. In several embodiments, during the device initial setup, the content management server verifies that the user and device qualify for a predetermined deal for a third-party service. For example, the content management server may verify that the user and device qualify for a deal by: (1) receiving a deal code and other information and recording it in a log; and (2) processing the log to award the deal by verifying other information provided. In various embodiments, the information received by the content management server may include user information, a deal code preloaded on the mobile device, and a unique mobile device identification number. The content management server may associate the deal with an existing user account for the service or with a new user account for the service that is established during setup of the mobile device. It should be understood that a deal code can take any appropriate form. In various embodiments, the deal code may be represented by a unique series of numbers and letters, a special type of file (e.g., a Java Archive file), or a calculated hash value based on various collected user data. Additionally, the deal code may be unique to a specific device or the same for each device manufactured by a particular company. The content management server may determine whether the deal code is valid for the identified mobile device and user by comparing information about the user, the mobile device, and the service terms with previously stored information. For example, by comparing a hash value based on user, mobile device, and service term information with a list or table of previously compiled hash values. The content management server may then grants a particular deal for the service to the user if the use of the deal code is valid.

In various embodiments, the deal may include granting the user of the mobile device a predetermined service package for cloud-based storage space for the content management system. Cloud-based storage space is advantageous because storage space on mobile devices may be limited. Thus, in some embodiments, from a high level, if the content management server verifies that the device and the user qualify for the predetermined service package for cloud-based storage space, the content management server grants the storage space to the user. More specifically, in various embodiments, an application associated with the content management server is pre-loaded on a mobile device. In several embodiments, when a user is setting up the mobile device, the application may get data from the content management system. The application may get the data in several ways. In some embodiments, the application may “fetch” a file on the content management system. In other embodiments, the application may simply access a file on the content management system. The application may then send user information, device information, and an associated deal code to the content management server. The content management server, based on the received data, either associates the granted cloud-based storage space with an existing user account of the user or with a new user account that is created during the setup of the mobile device.

In other embodiments, the content management server may grant a particular set of service terms after the user satisfies a predetermined criterion. For example, if the user and the device qualify for the deal, then the service terms of the deal are associated with the user account after the user completes a “getting started” tutorial for the content management system. Once the content management server verifies the device and the user information, the content management server sends a notification back to the mobile device to notify the user that they qualify for the particular set of service terms.

In several embodiments, system may maintain a report of all devices and users that have obtained the particular set of contract terms to prevent abuse. For example, mobile device users may attempt to copy the deal code and content management system application to other mobile devices in an attempt to obtain the deal on another mobile device that does not qualify the user for the particular set of contract terms. To minimize abuse, the content management system may track and maintain a record of: each user that obtains the particular set of contract terms; the mobile device identification number associated with the user; and various other information that allows the content management system to determine whether the deal code and an application associated with the service are improperly used on a mobile device that does not qualify for the deal. If fraud is detected, the content management system may remove the particular set of service terms from the user's account and records an entry in the content management database. The entry may contain the user information and device identification number so that the system can track users who improperly use the deal code.

The present system and method is advantageous in that the service provider can detect improper use of deal codes to minimize the likelihood that users fraudulently obtain the particular set of service terms with mobile devices that do not qualify for the deal. Moreover, the third-party service provider can prevent users from obtaining the benefits of a deal more than once by tracking user information (e.g. by user information and mobile device identification number) in a database for users who are granted the deal. Maintaining a listing of the mobile device identification numbers also allows the service provider to remove a device that has already qualified a user for the deal from the database if the device is returned and resold to a new user. This way, the new user can obtain the benefits of the deal using the refurbished mobile device. For purposes of this disclosure, the term out-of-box experience (OOBE) is a marketing term that describes the experience that a consumer (or user) has when first performing the initial setup and configuration of a mobile device. Because the third-party service is integrated into the OOBE, the third-party gains an advantage over other application and service providers by getting the user to sign up for, and use, the third-party application and related service.

Exemplary Technical Platforms

The present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

Exemplary System Architecture

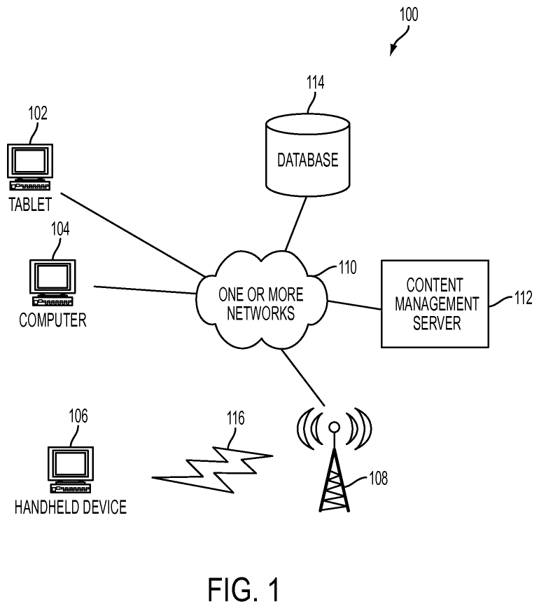

FIG. 1 is a block diagram of content management system 100 according to a particular embodiment. As may be understood from this figure, content management system 100 includes remote computing devices such as tablet computer 102, desktop or laptop computer 104, or mobile computing device 106 (e.g., a handheld device, a laptop, a tablet computer, a cellular phone, a smart phone, or any other device capable of transferring files over network 110) that are in communication with content management server 112 (which, for example, may be used to execute one or more modules as described below) and content management database 114 (which, for example, may be used to store the files on the content management system) via one or more networks 110. Networks 110, between content management server 112 and client devices 102, 104, and 106, may be, for example, implemented via one or more wired or wireless networks such as LANs, WANs, a cellular network, a Wi-Fi network, or via the Internet. For purposes of ease of explanation and clarity, no specific cellular network is shown in FIG. 1 as a network for a mobile device. However, a cellular tower may be coupled to a cellular network provider, which may be operatively coupled to network 110. The users of each of tablet computer 102, desktop computer 104, and mobile device 106 may have file storage accounts on content management server 112.

Network 110 may include any of a variety of types of wired or wireless communication networks, such as the Internet. The communication link between content management server 112 and content management database 114 may be, for example, implemented via a LAN, WAN, or via the Internet. Mobile device 106 may transmit data wirelessly over cellular network by communicating with a cellular tower 108. For purposes of ease of explanation and clarity, cellular tower 108 is shown coupled to networks 110. However, the cellular tower may be coupled to a cellular network provider, which is operatively coupled to network 110.

In various embodiments, content management server 112 may include one or more servers that are located in close physical proximity, or some servers may be locally together and others remote. In either case, all devices, wherever located, function as a system.

Content management server 112 enables file access and file storage between content management server 112 and client devices remote computing devices 102, 104, and 106. Content management server 112 receives files from and sends files to remote computing devices 102, 104, 106 consistent with the user's preferences for sharing files. Content management server 112 may act as the counterpart to a client-side file storage service client application user interface that allows a user to manipulate files directly stored on content management server 112. In some embodiments, software operating on remote computing devices 102, 204, 106 integrates network-stored files with the client's local file system to enable a user to manipulate network-stored files through the same user interface (UI) used to manipulate files on the local file system, e.g., via a file explorer, file finder or browser application. As an alternative or supplement to the client-side file explorer interface, content management server 112 may provide a web interface for remote computing devices 102, 104 106 to access (e.g. via a web browser) and allow a user to manipulate files stored on content management server 112. In this way, the user can directly manipulate files stored on content management server 112.

In various embodiments, content management database 114 stores files such as those uploaded using remote computing devices 102, 104, 106. It should be understood that, in various embodiments, content management database 114 may include of multiple data stores—some local to, and some remote from, content management server 112.

Content management database 114 maintains, for each user in a file journal, information identifying the user, information describing the user's file directory, etc. In some embodiments, the file journal is maintained on content management server 112. This file journal may be updated periodically using information obtained directly from content management server 112 and/or from information obtained from one or more client devices 102, 104, and 106 linked to the user's account. In this way, the server-stored file journal (hereinafter the “server-side file journal”) is updated when a file is changed either on the server or on one of the client devices associated with the user's account. When a file is changed, content management server 112 propagates the change to each client device associated with the user's account. For example, if a user makes a change to a particular file on a first client device, the change may be reflected in the server-side file journal. The system then uses the server-side file journal to propagate the change to all client devices associated with the user's account. Such techniques may be implemented, for example, within the context of a synchronized file system such as the Dropbox™ Service of Dropbox, Inc. of San Francisco, Calif.

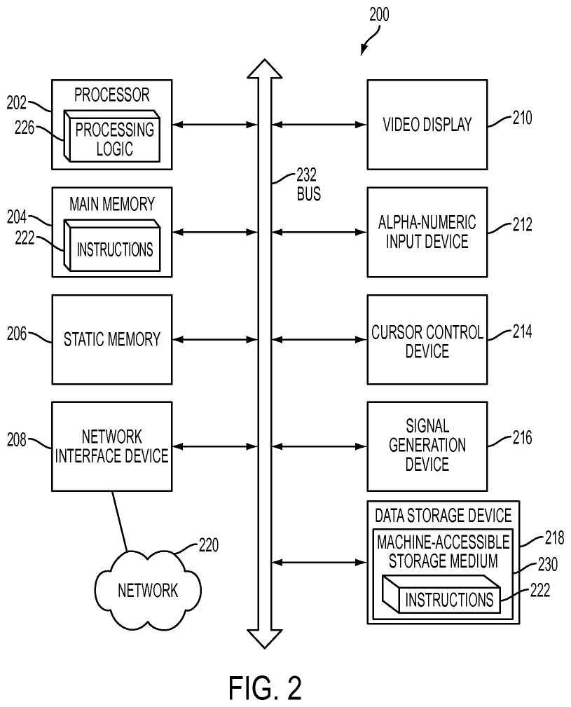

FIG. 2 illustrates a diagrammatic representation of computer 200 that can be used within content management system 100, for example, as client computer 102, 104, or 106 (FIG. 1), or as content management server 112 (FIG. 1). For purposes of this disclosure, reference to a server or processor, shall be interpreted to include either a single server, a single processor, or multiple servers, or multiple processors.

In particular embodiments, computer 200 may be connected (e.g., networked) to other computers by a LAN, WAN, an intranet, an extranet, and/or the Internet. Computer 200 may operate in the capacity of a server or a client computer in a client-server network environment, or as a peer computer in a peer-to-peer (or distributed) network environment. Computer 200 may be a personal computer (PC), a tablet PC, a mobile device, a web appliance, a server, a network router, a switch or bridge, or any computer capable of executing a set of instructions (sequential or otherwise) that specify actions to be taken by that computer. Further, while only a single computer is illustrated, the term “computer” may also include any collection of computers that individually or jointly execute a set (or multiple sets) of instructions to perform any one or more of the methodologies discussed herein.

Exemplary computer 200 may include processor 202, main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and data storage device 218, which communicate with each other via bus 232.

Processor 202 may represent one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 202 may also be one or more special-purpose processing devices such as an application specific integrated circuit (ASIC), a field programmable gate array (FPGA), a digital signal processor (DSP), a network processor, or the like. Processor 202 may be configured to execute processing logic 226 for performing various operations and steps discussed herein.

Computer 200 may further include a network interface device 208. Computer 200 also may include video display 210 (e.g., a liquid crystal display (LCD) or a cathode ray tube (CRT)), alphanumeric input device 212 (e.g., a keyboard), cursor control device 214 (e.g., a mouse), and signal generation device 216 (e.g., a speaker).

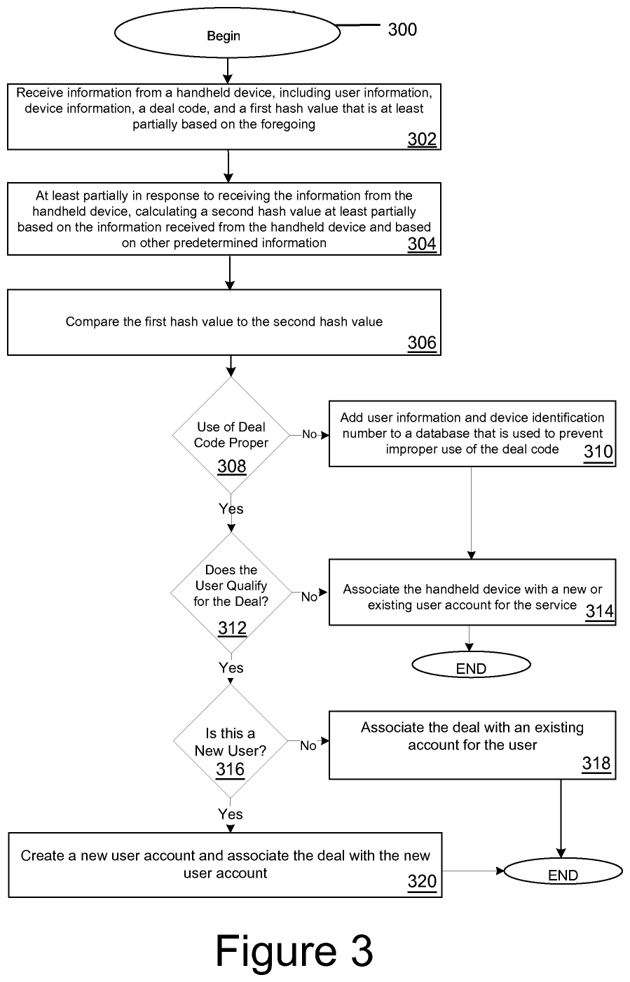

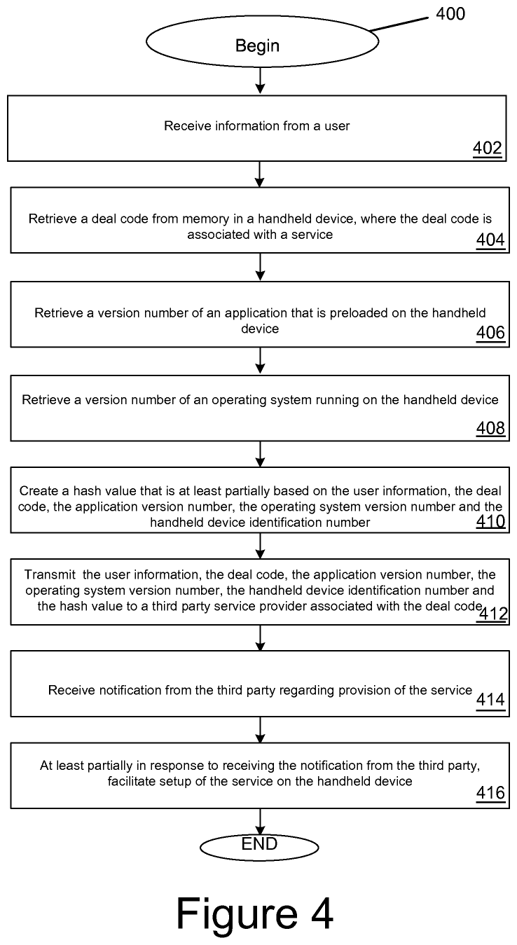

Data storage device 218 may include machine accessible storage medium 230 (also known as a non-transitory computer-accessible storage medium, a non-transitory computer-readable storage medium, or a non-transitory computer-readable medium) on which is stored one or more sets of instructions (e.g., a deal code abuse detection module and a software initiation module, which is configured to carry out the steps illustrated in FIG. 3 and FIG. 4) embodying any one or more of the methodologies or functions described herein. A deal code abuse detection module and a software initiation module, may also reside, completely or at least partially, within main memory 204 and/or within processing device 202 during execution thereof by computer 200, main memory 204, and processing device 202 also constituting computer-accessible storage media. Instructions 222 (e.g., deal code abuse detection module and software initiation module) may further be transmitted or received over network 220 via network interface device 208.

While machine-accessible storage medium 230 is shown in an exemplary embodiment to be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical, and magnetic media.

Exemplary System Operation

Devices 102, 104, 106 and content management server 112 may alone, or in combination, perform the method steps of FIGS. 3 and 4. It should be understood by reference to this disclosure that these methods describe exemplary embodiments of the method steps carried out by the present system, and that other exemplary embodiments may be created by adding other steps or by removing one or more of the method steps described in FIGS. 3-4.

FIG. 3 shows steps that exemplary deal code abuse detection module 300 may provide for determining whether a new mobile device and user are eligible for a particular deal with a third-party for a service on the mobile device. Beginning at step 302, the content management server may receive information from a mobile device, which may be transmitted over a cellular connection or over a Wi-Fi connection that may be established during the setup of the mobile device. In various embodiments, an application associated with the content management server is pre-loaded on a mobile device. In several embodiments, when a user is setting up the mobile device, the application may “fetch” a file on the content management server. In other embodiments, the mobile device may simply access a file on the content management system. The application may then send to the content management server. The information sent to the content management server may be sent in response to the user entering the information during the setup of the mobile device. In various embodiments, the information may contain: (1) user information; (2) a deal code that is preloaded on the mobile device by the manufacturer of the mobile device or by a wireless carrier associated with the mobile device; (3) mobile device information; and (4) a first hash value that is at least partially calculated based on the foregoing.

In various embodiments, the mobile device information may include a mobile device identification number and a version number of the operating system that is running on the mobile device. The device information may also include the version number of an application that is associated with the service that has been preloaded on the mobile device before it is received by the user. In some embodiments, the user information may include a username and password. The username may be, for example, an e-mail address or any suitable username accepted by the third-party service provider (e.g., the content management server of a content management system). In various embodiments, the unique mobile device identification number may be the electronic serial number for the mobile device. In other embodiments, the mobile identification number may be any other suitable identifier that allows the content management system to track an individual mobile device.

In various embodiments, the deal code may be a unique code associated with the manufacturer and model of the mobile device. That is, the same deal code may be used on all like models of the mobile device. In other embodiments, the deal code may be associated with the wireless carrier that provides cellular service to the mobile device. As discussed above the deal code may be preloaded onto the mobile device prior to the mobile device being shipped to the retail seller (e.g., by the manufacturer or other intermediary). The deal code may be stored in the mobile device memory in a file such as a Java Archive file. In various embodiments, the deal code may be encrypted to help prevent unauthorized use of the code. It should be understood that a deal code can take any appropriate form. In various embodiments, the deal code may be represented by a unique series of numbers and letters, a special type of file (e.g., a Java Archive file), or a calculated hash value based on various collected user data. Additionally, the deal code may be unique to a specific device or the same for each device manufactured by a particular company.

At step 304, to receiving the information, the content management server may calculate a second hash value. The second hash value may be calculated based on the information received from the mobile device and based on other predetermined information stored in the content management database. In various embodiments, the other predetermined information may include a known application version number and a known operating system version number that are associated with the deal code. That is, when a deal is negotiated with a mobile device manufacturer or wireless carrier, the third-party service provider may know in advance the version number of the application that is preloaded on the mobile device and the version number of the operating system that will ship on the mobile devices associated with the deal code. As a result, the content management server can calculate the second hash value using the expected known information in combination with the user information, the deal code, and the mobile device identification number. The second hash value may be used to determine if the information sent from the mobile device qualifies the user for the deal associated with the deal code.

At step 306, content management server 112 may compare the second hash value to the first hash value. Because the hash values are calculated using the same hash function and the second hash value is calculated using predetermined information about the mobile device, if the content management server detects differences between the first hash value and the second hash value, the content management server, at step 308, may make a determination that the user is improperly using the deal code on a mobile device that does not qualify for the deal. If the hash codes are not equal, at step 310 the content management server may add the user information and device identification number to a database that is used to prevent improper use of the deal code. In various embodiments, even if the content management system detects that the user is improperly using a deal code, the server may, at step 314, associate the mobile device with a new or existing user account for the service under standard service terms. This way, the user may receive the standard set of service terms, but gains the benefit of using the content management services on the mobile device.

If, in the alternative, the system determines that the hash values are equal, the content management server, in various embodiments, may confirm that: (1) the mobile device qualifies the user for a particular set of service terms; (2) that the particular set of service terms was not already granted to another user of the mobile device; (3) and in some embodiments, that the user has satisfied at least one criterion. The criterion may be, for example, the completion of a tutorial on the third-party service.

In various embodiments, content management server 112 determines whether the mobile device qualifies for the deal based on the deal code and the mobile device identifier. In various embodiments, a device may qualify for the deal if the device manufacturer pre-negotiates a deal with the third-party vendor for provision of the content management system services under particular service terms. If the mobile device qualifies for the deal, then at step 312, the content management server may determine whether the user associated with the mobile device qualifies for the deal. If the user does not qualify for the deal, the content management server moves to step 314, and may notify the user that they do not qualify for the deal. In various embodiments, the content management server may associate the mobile device with a new or existing user account under the standard service terms. For example, a user may not qualify for a particular set of service terms, even though the mobile device qualifies for the particular set of service terms, if the user was previously granted the particular set of service terms using another qualifying mobile device.

If, on the other hand, the user qualifies for the deal, then at step 316, the content management server may determine if the user is new to the content management system. In various embodiments, the user can indicate if they are an existing or new user when setting up the mobile device. For example, the third-party service screen in the OOBE may allow the user to select an “I already have an account” menu item 1104 (FIG. 11) or a “Create a new content management service account” menu item 1102 (FIG. 11). As such, in various embodiments, the user information received by the content management server may contain an indication whether the user is a new or an existing user to the content management system. If the user selected the “Create a new content management service account” menu item 1102, the content management server, at step 320, may create the new account and associate the particular set of service terms with the new user account. Otherwise, at step 318, the content management server may log the user into their existing account and associates the particular set of service terms with the user's existing account.

In various embodiments, the user information, deal code, and mobile device identification number are stored in the content management database 114. Additionally, the contract terms (e.g., the particular set of service terms associated with the deal or the standard service terms) associated with the user's account may also be stored in content management database 114. This way, content management server 112 can manage the user's account with respect to the particular contract terms granted to the user. For example, in some embodiments, the particular contract terms may grant the user a predetermined amount of free storage space on the synched content management system for a fixed length of service. Content management server 112 may use the stored information to manage the user's account and provide a renewal notice when the fixed length of service expires. The user and device information stored in content management database 114 may allow content management server 112 to sync file data among multiple client devices (e.g., tablet 102, computer 104 and mobile device 106) associated with the user's account.

FIG. 4 shows the method steps provided by software initiation module 400, in accordance with various embodiments of a mobile device, where a deal code may be used to provide a particular set of service terms, for a service provided by a third-party, on a mobile device. Beginning at step 402, mobile device 106 (FIG. 1) receives information from a user. The information may be received during the initial setup of the mobile device. In particular, one or more screens in the mobile device OOBE may present the user of the mobile device with the opportunity to initiate a third-party service on the mobile device. For example, in one embodiment, the third-party service may be a cloud-based content management service where photos, files, and videos are stored by the third-party content management server and are made available to the user of the mobile device. This way, the files, photos, and videos may not deplete the memory on the mobile device and may be downloaded in real-time when the user wants to view or edit a file.

At step 404, in response to receiving the information from the user, the mobile device may retrieve a deal code from memory in the mobile device. The deal code may be included in a file stored on the mobile device. For example, in various embodiments, the deal code may be stored within a Java Archive file. The deal code may be a unique code that associates particular service terms with a particular mobile device model or wireless carrier. As such, in various embodiments, the third-party service provider may pre-determine the particular service terms with a mobile device manufacturer and/or wireless carrier. In exchange for providing advantageous service terms to the mobile device user, in various embodiments, the manufacturer may integrate the third-party service provider application and service setup screens into the mobile device OOBE.

At step 406, the mobile device may retrieve a version number of an application that is preloaded on the mobile device. In various embodiments, the application may be a client application that integrates the third-party service on the mobile device. Thus, the third-party service provider may provide the manufacturer a particular version of the application in conjunction with the deal code. The deal code and the particular version of the application may be preloaded on the mobile device prior to the mobile device being delivered to the user, which may then be integrated into the setup screens for the mobile device OOBE. At step 408, the mobile device may retrieve a version number of an operating system running on the mobile device. In some embodiments, the third-party service provider may use the application version number and the operating system version number in determining whether use of the deal code is a valid use. For example, at step 410, the mobile device may use a hash function provided by the third-party service provider to create a hash value that is at least partially based on the user information, the deal code, and the information about the mobile device. In some embodiments, the information about the device may include the device identification number, the application version number, and the operating system version number. In various embodiments, the hash value may also be based on at least a portion of the binary code of the application.

At step 412, the mobile device may transmit the hash code and at least one or more of the user information, and the information about the mobile device to the third-party service provider associated with the deal code. The information about the mobile device may include at least one or more of the mobile device identification number, the operating system version number, the application version number, and any other suitable piece of information related to the mobile device or the application. The third-party provider may use the transmitted hash code, the user information, and the mobile device information to confirm that the calculated hash code is valid by calculating an expected hash code based on the user information and known information about the mobile device.

At step 414, if the calculated hash value matches the hash value received by the third-party service provider, the mobile device may receive a notification that is sent from the third-party service provider regarding the provision of the services. In various embodiments, the notification may include at least one of: a welcome notice; a terms of service notice; a deal qualification notice; and a notification of at least one criterion that must be completed before the deal is granted to the user. At step 416, to receive the notification from the third-party, the mobile device may enable setup of the service (for example, synching data on a content management system or auto-populating photo gallery views) on the mobile device.

In various embodiments, the content management system is a synched content management system. In other embodiments, the service on the mobile device automatically populates a photo gallery on the mobile device or automatically uploads files from the mobile device to the content management system.

Example User Experience

When a user purchases a mobile device, in most cases, the user must setup the mobile device prior to using the device, which is performed by the user through the mobile device's OOBE. Setup is performed by navigating through one or more setup screens that allows a user to select options to customize the mobile device to their liking. The following discussion is directed to various embodiments of an OOBE that the user may experience when setting up their mobile device.

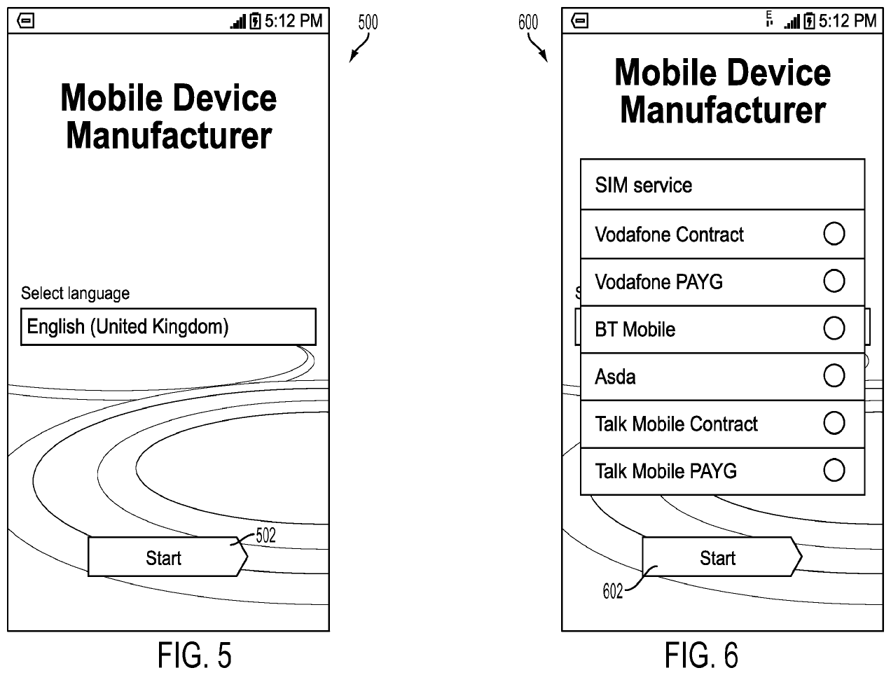

Referring to FIG. 5, when the user powers on the mobile device for the first time, the mobile device may present the user with welcome screen 500. The user may select their local language and select “start” menu item 502 to advance to the next screen. Referring to FIG. 6, in some embodiments, the user may also select the mobile network on “Sim service” screen 600. Once the user selects the mobile network provider, they may select “start” menu item 602 to continue the setup process.

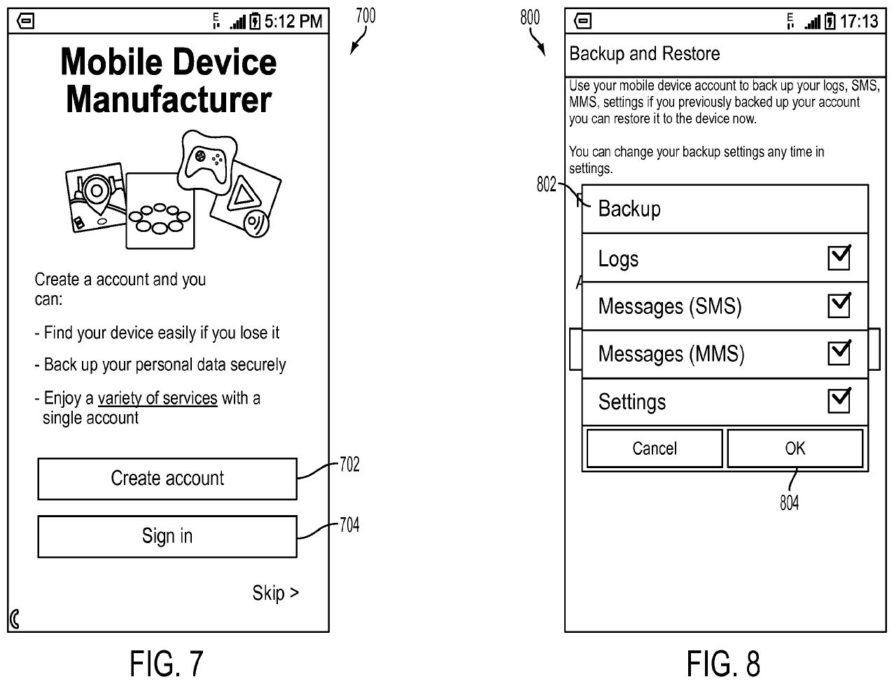

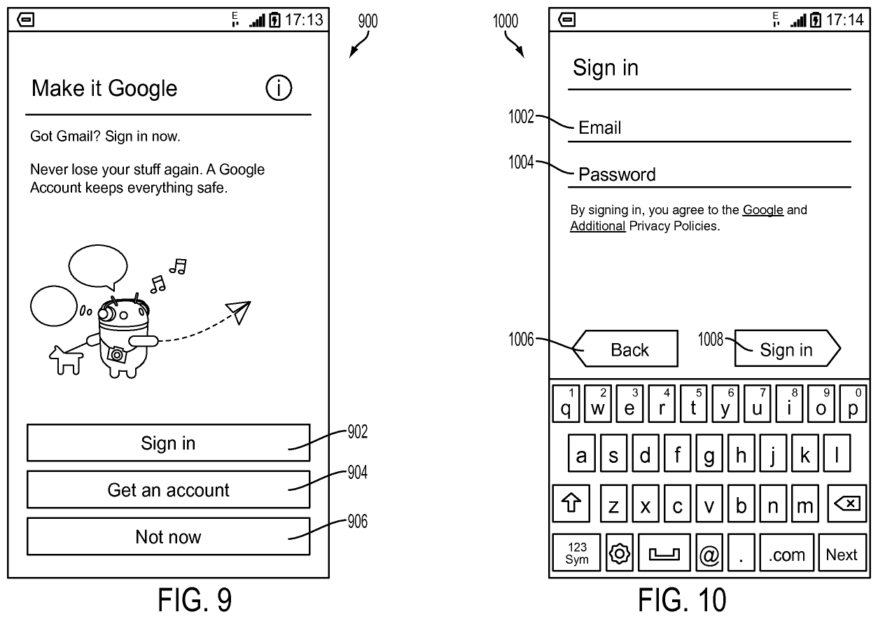

Referring to FIG. 7, the mobile device presents the user with device manufacturer account screen 700 that may allow the user to associate the mobile device with an account hosted by the mobile device manufacturer. In the example shown, the user may either set up an account with a mobile device manufacturer by clicking “create account” menu item 702, or log into an existing mobile device manufacturer account by selecting “sign in” menu item 704. The user may already have a mobile device manufacturer account if they have previously owned a mobile device manufactured by the same company. Referring to FIG. 8, once the user logs into an existing account or creates a new account, backup screen 800 may be displayed that allows the user to backup and restore SMS messages, call logs, and certain settings by selecting items on “backup” screen 802. Thus, if the user has to reset the mobile device for any reason, or if the user buys a new mobile device, the user can restore saved information to the new device, or the reset old device. Once the user selects their backup settings, the user may hit “ok” menu item 804 to advance to the next screen.

In various embodiments, the OOBE may be configured to present the user with the ability to associate the mobile device with a third-party service provider. In particular, and referring to FIG. 11, content management service screen 1100 presents the user with a deal that relates to the provision of a predetermined service package, such as free cloud-based storage space with an account on a synched content management system (e.g., Dropbox, Inc.). In the current example, the manufacturer of the mobile device negotiated a deal with content management service to provide the user with 50 free GB of cloud storage on the content management service synched content management system. To take advantage of this deal, screen 1100 provides the user with an option to create a new account by selecting “Create a new content management service account” menu item 1102 or to log into an existing content management service account by selecting “I already have an account” menu item 1104. The user may also select “No thanks” menu item 1106, which allows the user to skip over the deal offering. However, if the user selects “No thanks” menu item 1106, they can later return to this menu option to take advantage of the deal offering. If the user already has a content management service account, the content management service system will associate the deal offering with the user's existing account. Associating the mobile device with a content management service account allows the user to store data files, including photos and video in their cloud-based storage account. In this way, the user can maximize the amount of local memory that is available to the user while maintaining the ability to view and download content as needed.

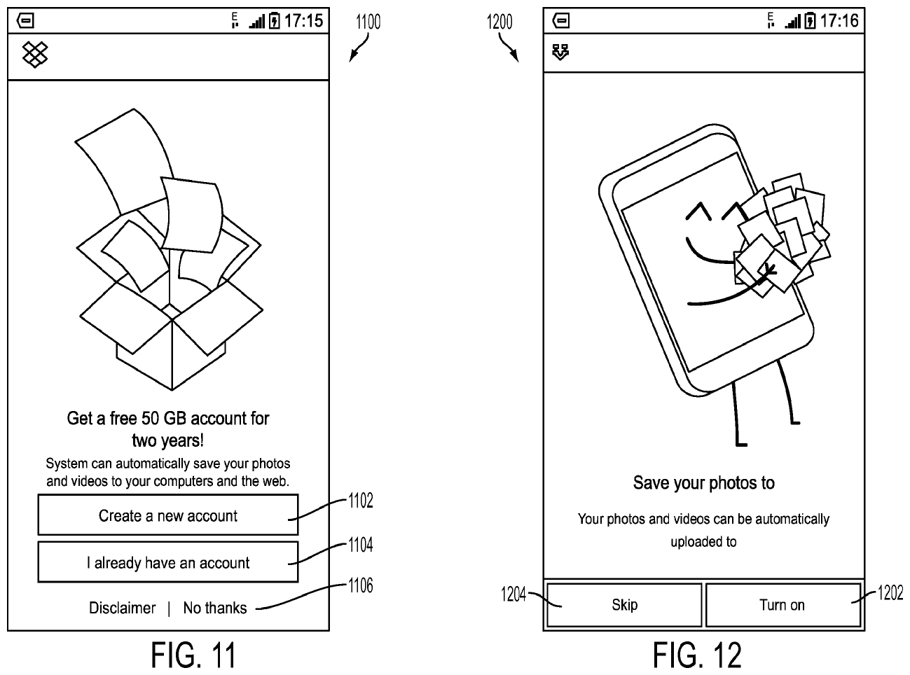

Once the user is finished creating a new content management service account or logging in to their existing account, referring to FIG. 12, the OOBE presents the user with camera upload screen 1200 that allows user enable an automatic photo upload feature by selecting “Turn on” menu item 1202. If the user does not wish to enable the photo upload feature, they can select “Skip” menu item 1204 to advance to the next screen. The camera upload feature allows the mobile device to automatically send photos, videos, and screenshots taken on the mobile device to a private folder in the user's content management service account.

One of skill in the art, with reference to this disclosure, should understand that various other OOBE screens may be included in the setup and initialization of the mobile device.

### CONCLUSION

Having the benefit of the teachings presented in the foregoing descriptions and associated drawings, one of skill in the art will recognize many modifications and other embodiments of the invention.

In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A method comprising:
storing in a database at a content management system, a plurality of codes, a plurality of predetermined operating system version numbers, and a plurality of predetermined application version numbers, each of the plurality of codes being associated with at least one of the plurality of predetermined operating system version numbers and at least one of the plurality of the predetermined application version numbers;
receiving at the content management system, from an application associated with the content management system and running on a mobile device, user data associated with the mobile device, a code preloaded into a memory of the mobile device, a first hash value calculated at the mobile device by a hash function using the code, an operating system version number corresponding to an operating system running on the mobile device, and an application version number corresponding to the application associated with the content management system and running on the mobile device;
in response to receiving the code and the first hash value at the content management system, retrieving, by the content management system from the database using the code, a predetermined operating system version number and a predetermined application version number;
calculating, at the content management system, a second hash value by the hash function using the code, the predetermined operating system version number, and the predetermined application version number;
comparing the second hash value to the first hash value; and
validating the code at least partially based on the comparison of the second hash value to the first hash value.

2. The method of claim 1, further comprising:
associating the mobile device with a user account at the content management system when the first hash value is equal to the second hash value; and
storing, at the content management system, the user data associated with the mobile device, wherein the database maintains user information and device information.

3. The method of claim 2, further comprising:
storing, at the content management system in the user account, a content item received from the application associated with the content management system and running on the mobile device.

4. The method of claim 2, wherein the step of associating the mobile device with the user account further comprises:
receiving a mobile device identification number associated with the mobile device at the content management system; and
adding the user data and the mobile device identification number to the database to prevent the user, and any other user of the mobile device, from obtaining a particular set of service terms associated with the code, when the first hash value is not equal to the second hash value.

5. The method of claim 2, wherein the step of associating the mobile device with the user account further comprises granting, to the user, a particular set of terms for a third-party service.

6. The method of claim 1, further comprises:
determining whether the application associated with the content management system has been modified.

7. The method of claim 6, further comprising:
receiving a mobile device identification number associated with the mobile device at the content management system; and
in response to determining that the application associated with the content management system has been modified, adding the user data associated with the mobile device and the mobile device identification number to a database preventing improper use of the code.

8. The method of claim 1, wherein the code is associated with cloud-based storage space on the content management system.

9. A non-transitory computer-readable medium comprising:
instructions stored thereon which, when executed by one or more processors, cause a computing device to:
store a plurality of codes, a plurality of predetermined operating system version numbers, and a plurality of predetermined application version numbers, each of the plurality of codes being associated with at least one of the plurality of predetermined operating system version numbers and at least one of the plurality of the predetermined application version numbers;
receive from an application running on a mobile device, user data associated with the mobile device, a code preloaded into a memory of the mobile device, and a first hash value calculated at the mobile device by a hash function using the code, an operating system version number corresponding to an operating system running on the mobile device, and an application version number corresponding to the application associated with the content management system and running on the mobile device;
in response to receiving the code and the first hash value, retrieve using the code, a predetermined operating system version number and a predetermined application version number;
calculate a second hash value by the hash function using the code, the predetermined operating system version number, and the predetermined application version number;
compare the second hash value to the first hash value; and
validate the code at least partially based on the comparison of the second hash value to the first hash value.

10. The non-transitory computer-readable medium of claim 9, further comprising:
associate the mobile device with a user account when the first hash value is equal to the second hash value; and
store the user data associated with the mobile device, user information, and device information.

11. The non-transitory computer-readable medium of claim 9, further comprising:
store in the user account, a content item received from the application running on the mobile device.

12. The non-transitory computer-readable medium of claim 9, further comprising:
receive a mobile device identification number associated with the mobile device; and
store the user data and the mobile device identification number to prevent the user, and any other user of the mobile device, from obtaining a particular set of service terms associated with the code, when the first hash value is not equal to the second hash value.

13. The non-transitory computer-readable medium of claim 9, further comprising:
receive a mobile device identification number associated with the mobile device at the content management system;
determine whether the application has been modified; and
in response to determining that the application has been modified, store the user data associated with the mobile device and the mobile device identification number to prevent improper use of the code.

14. A system to verify a code associated with a service, the system comprising:
one or more processors; and
at least one computer-readable medium storing instructions which, when executed by the one or more processors, cause the system to:
store a plurality of codes, a plurality of predetermined operating system version numbers, and a plurality of predetermined application version numbers, each of the plurality of codes associated with at least one of the plurality of predetermined operating system version numbers and at least one of the plurality of the predetermined application version numbers;
receive from an application associated with the system and running on a mobile device, user data associated with the mobile device, the code preloaded into a memory of the mobile device, a first hash value calculated at the mobile device by a hash function using the code, an operating system version number corresponding to an operating system running on the mobile device, and an application version number corresponding to the application associated with the system and running on the mobile device;
in response to receiving the code and the first hash value, retrieve using the code, a predetermined operating system version number and a predetermined application version number;
calculate a second hash value by the hash function using the code, the predetermined operating system version number, and the predetermined application version number;
compare the second hash value to the first hash value; and
validate the code at least partially based on the comparison of the second hash value to the first hash value.

15. The system of claim 14, further comprising:
associate the mobile device with a user account when the first hash value is equal to the second hash value; and
store the user data associated with the mobile device, user information, and device information.

16. The system of claim 14, further comprising:
receive a content item from the application associated with the system and running on the mobile device; and
store the content item in the user account.

17. The system of claim 14, further comprising:
receive a mobile device identification number associated with the mobile device; and
store the user data and the mobile device identification number to prevent the user, and any other user of the mobile device, from obtaining a particular set of service terms associated with the code, when the first hash value is not equal to the second hash value.

18. The system of claim 14, wherein to associate the mobile device with the user account further comprises granting, to the user, a particular set of terms for a service.

19. The system of claim 14, wherein to compare the second hash value to the first hash value comprises to determine whether the application associated with the system has been modified.

20. The system of claim 19, further comprising:
receive a mobile device identification number associated with the mobile device; and
wherein if the application associated with the system has been modified, store the user data associated with the mobile device and the mobile device identification number to prevent improper use of the code.
